(19) United States
(12) Patent Application Publication
(10) Pub. No.: US 2010/0072205 A1
(43) Pub. Date: Mar. 25, 2010

(54) DIAPHRAGM

(75) Inventor: Iain Charles Edward Stuart, Abingdon Oxfordshire (GB)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Crown Packaging Technology, Inc., Alsip, IL (US)

(21) Appl. No.: 12/438,670

(22) PCT Filed: Aug. 10, 2007
(86) PCT No.: PCT/EP2007/058317

§ 371 Date: May 7, 2009

(30) Foreign Application Priority Data
Aug. 24, 2006 (EP) 06119446.0

(51) Int. Cl. B65D 51/18; B65D 53/00; A47J 43/28

(52) U.S. Cl. 220/254.3; 220/378; 220/254.7; 30/324

(57) ABSTRACT

A first aspect of the present invention relates to a diaphragm (2) for sealing an access opening (5) of a container body (6), the diaphragm being semi-rigid and formed with a shaped cavity (10). The present invention is particularly (but not exclusively) suitable for use with metal cans for packaging foodstuffs. A second aspect of the present invention relates to a reinforcing support (14) for locating over the diaphragm when used to seal an access opening of a container body. A third aspect of the present invention relates to a spoon (26) suitable for use with a container comprising the diaphragm.

### TECHNICAL FIELD

A first aspect of the present invention relates to a diaphragm for sealing an access opening of a container body, the diaphragm being semi-rigid and provided with a shaped cavity. The present invention is particularly (but not exclusively) suitable for use with metal cans for packaging foodstuffs. A second aspect of the present invention relates to a reinforcing support for locating over the diaphragm when used to seal an access opening of a container body. A third aspect of the present invention relates to a spoon suitable for use with a container comprising the diaphragm.

### BACKGROUND ART

Containers for the packaging of non-liquid foodstuffs, such as milk powder, are known. Such a known container comprises a container body of generally circular cross-section, the container body having a sidewall and a base. The end of the container body opposite the base defines an access opening through which the foodstuff may be dispensed from the container. A closure—in the form of a removable foil membrane—is attached to the container body to cover and seal the access opening and thereby maintain food freshness. The foil membrane defines a generally planar surface. Additionally, a separate lid may be releasably attached over the access opening to cover and protect the foil membrane. The known container also includes a spoon (or similar utensil) for conveniently dispensing the foodstuff from the container via the access opening. When first filling the container, the spoon would be inserted into the container along with the foodstuff. However, by the time the filled container reaches an end-consumer, settlement of the foodstuff which is stored in the container may well cause the spoon to become buried in the foodstuff. This then requires the end-consumer, after having first removed the foil membrane from the container, to delve into the foodstuff to first find and then remove the spoon.

To assist in overcoming the above problems, cardboard containers are known for the storage of non-liquid foodstuff, which include a foil membrane sealed part-way down the inside wall of the cardboard container and away from the access opening to define a generally planar surface. The planar surface of the foil membrane thereby defines two compartments within the cardboard container:

a) a first compartment below the membrane for housing the foodstuff; and

b) a second compartment above the membrane providing a cavity for storage of the spoon.

Patent Citation 0001: WO WO 2005/075314 A (N.V. NUTRICIA). 2005-08-18. discloses such a cardboard container (see FIG. 4 of WO 2005/075314) for “pulverent material” (i.e. any granular/powdered material), with the container wall being a laminate of board/paper, a relatively thin layer of aluminium foil and a layer of plastic material. A planar membrane is sealed to the layer of plastic material that forms the inner surface of the container part-way down the inside of the container, with a spoon resting on top of the membrane.

This avoids the spoon becoming buried in the foodstuff—at least until the container is opened by the end-consumer. However, the simple planar construction of the membrane means that the volume taken up by the second compartment is far larger than that physically required for housing the spoon. Considered from another perspective, the excess volume taken up by the second compartment means that there is less volume available within the container for storing the foodstuff. In summary, there is an inefficient use of space within the container.

The problems described above would be equally applicable to containers for the packaging of other non-liquid matter. For containers used for the storage of liquid matter and including a spoon within the container, a further problem would occur in that the spoon would become wet and/or sticky to the touch—something that is undesirable to the end-consumer.

Minimising weight and use of raw materials is also an important consideration in the field of packaging.

Consequently, there is a need for a lightweight means for closing a container, which defines separate compartments within the container whilst also improving the usable storage volume of the container.

### DISCLOSURE OF INVENTION

Accordingly, for a first aspect of the present invention, there is provided a diaphragm for a closure for sealing an access opening of a container body, characterised in that the diaphragm is semi-rigid and formed with an annular region surrounding a shaped cavity.

Diaphragms of the type described above would typically be formed of inherently thin material with low lateral stiffness—as implied by the term diaphragm. Shaping the cavity helps to provide the diaphragm with some rigidity—relative to a wholly planar diaphragm—and thereby offers resistance to pressure differentials. Shaping the cavity into a domed or part-spherical profile would minimise the presence of features, such as sharp corners, which would otherwise act as points of weakness on the diaphragm.

When incorporated into a container, the presence of a shaped cavity in the diaphragm increases the volume of the container that is left free for the contents relative to the background art previously described, consequently resulting in savings in raw materials during manufacture of the container.

The diaphragm may form the entirety of the closure itself; for example, it may be adapted to be attached directly to the sidewall of the container body. Alternatively, the diaphragm may be attached to an intermediate component—such as an annular ring—to thereby form the closure, the intermediate component itself being adapted for attachment to the container body. Where the container body is a metal can, the intermediate component may be a metal ring that is double-seamed onto the sidewall of the metal can.

Given that spoons are provided with a scoop portion, they are eminently suitable for efficient storage within a domed/part-spherical cavity, with the profile of the cavity more closely corresponding to the shape of the spoon than would a conventional planar membrane. Considering the example of containers for foodstuffs and medication, the presence of the cavity provides a space for efficiently and/or hygienically storing a spoon or similar utensil to enable the foodstuff/medication to be conveniently dispensed from the container, thereby avoiding the spoon or similar utensil becoming buried in the contents of the container prior to opening.

The cavity also provides convenient storage space for promotional items that would otherwise have to be supplied separately. Further, the cavity may be used for storing instructions and other literature that would otherwise have to be printed onto the outside of the container or supplied separately.

In a preferred embodiment, the diaphragm is circular in plan view, such as when made for sealing the access opening of a conventional cylindrical container body with a circular cross-section. However, the present invention is equally applicable to other shapes of container body, i.e. irregular/polygonal in cross-section and/or with a varying cross-section—the shape and size of the diaphragm being dependent on the shape and size of the container body in the vicinity of the access opening.

The diaphragm must be formed of material thick enough to provide at least some inherent stiffness/rigidity and avoid undesired splitting and/or tearing of the diaphragm, whilst thin enough to minimise weight and raw material costs. Conveniently, the diaphragm is formed from foil sheet. Using foil sheet provides weight advantages over the use of conventional can ends made from sheet metal, with the forming into a shaped cavity helping to provide rigidity/stiffness to the diaphragm. In a preferred embodiment, aluminium has been used as a material for the foil sheet. However, this does not preclude the use of other materials—such as plastics or other metals—which are suitable for providing the stiffness required for the diaphragm of the present invention. It is preferred that the diaphragm is formed from a single piece of foil. To provide the optimum balance between minimising use of material and providing stiffness/rigidity to the resulting diaphragm, it is preferred for the diaphragm to be formed from a foil with a metal thickness in the range 20 to 170 microns. More preferably, the metal thickness is in the range 90 to 150 microns.

In a preferred embodiment, the diaphragm is a laminate comprising a strengthening layer and a bond layer. The strengthening layer should provide the diaphragm with strength and stiffness. Foil sheet (as described above) is suitable for use as the strengthening layer, with aluminium having been found to be particularly advantageous. The bowl layer should permit the formation of a hermetic seal over the access opening. The bond layer may be an adhesive or a heat sealable material. However, in a preferred embodiment, the bond layer is formed of a peelable bonding material that allows the diaphragm, once attached to the container body, to be peelably removed from the container to expose the access opening—thereby avoiding the need to puncture the diaphragm or use other less efficient means to gain entry to the container. One example of a laminated diaphragm comprises a peelable bond layer of polymeric material, a layer of aluminium foil sheet of from 90 to 120 microns thickness and a print, lacquer or other coating.

Preferably, the diaphragm is formed from a single piece of unperforated foil. The avoidance of any holes/penetrations, etc within the diaphragm maximises the rigidity of the diaphragm, as well as simplifying the manufacturing process.

In a further embodiment of the present invention, the diaphragm comprises detaching means for assisting in removal of all or part of the diaphragm from the container—thereby avoiding the need for the diaphragm to be punctured in order to gain entry to the container's contents. The detaching means may include a tab, ring-pull or a combination of the two, or other known means. The detaching means may be formed integrally with the diaphragm, or attached to the diaphragm by heat-sealing, riveting or other conventional means. Forming the detaching means integral with the diaphragm reduces the number of discrete components that form the lid and thereby simplifies the manufacturing process for the lid. For example, the material for the diaphragm may initially be cut from a laminated foil sheet, with an integral tab extending from the periphery of the diaphragm.

Preferably, the shaped cavity is formed with a ratio of major diameter to cavity depth within the range 2.6:1 to 5.5:1. Cavity depth is defined as the depth measured from the periphery of the shaped cavity to the bottommost point of the cavity measured along the longitudinal axis of the diaphragm. By major diameter is meant the greatest distance measured in a straight line between two points on the cavity periphery. It is to be understood that the periphery of the cavity is not restricted to being generally circular in profile.

It has been found advantageous for the shaped cavity to be formed so that it is generally part-spherical in shape and describes an arc in the angular range 80° to 150°, the arc being in a parallel plane to the longitudinal axis of the diaphragm. A part-spherical profile provides the optimum strength and rigidity to the thin material of the diaphragm.

As the above ratio decreases and/or angle of the arc increases, the greater is the risk of tearing or splitting of the diaphragm—particularly at the bottom of the cavity, which is therefore a region of weakness. However, as the above ratio increases and/or the angle described by the arc decreases, the shallower the cavity that is formed (i.e. the less the cavity depth), and the shallower the item(s) that can be stored inside the cavity. The claimed ranges of i) ratio of major diameter:cavity depth and ii) arc angle have been found to minimise the risk of tearing/splitting, whilst also providing a cavity of sufficient depth and rigidity/strength.

In another embodiment, the diaphragm is formed with a weakening line situated outward of the shaped cavity, the weakening line defining a first removable portion inside the weakening line and a second non-removable portion outside the weakening line. This feature of the present invention avoids the need to remove the entirety of the diaphragm from the container in order to gain entry to its contents, which may typically involve the use of relatively expensive peelable bonding materials to attach the diaphragm directly/indirectly to the container body. Consequently, there is potential for the use of cheaper materials to form the seal between the diaphragm and the container body. The weakening line may be formed by scoring the diaphragm or other conventional means.

Conveniently, the annular region may be formed with at least one inclined area that extends about all or part of the annular region and converges towards the cavity. The depth required for the cavity would be dependent on the size of item intended to be stored in the cavity. Conveniently, the profile of the cavity would be formed by using a conventional drawing process on a blank of material. The cavity may be formed either before or after attachment of the diaphragm to the container body. The use of an inclined area adjoining the cavity reduces the tendency for tearing and/or splitting because the material required to form the cavity is drawn from a larger area of the diaphragm, with the inclined area contributing to the lowermost point of the cavity. Conveniently, the at least one inclined area comprises two or more regions inclined relative to each other. Additionally, the use of an inclined area helps to enhance the rigidity of the resulting diaphragm.

It has been found that ensuring the maximum angle of inclination of the at least one inclined area is less than or equal to 35° assists in reliable cavity formation. Further, when used on a diaphragm which is adapted for peelable removal from a container, such an inclination angle assists in ensuring that the diaphragm can be removed in an efficient peeling action with the minimum of effort required by the end-user. Most preferably, the maximum angle of inclination is in the range 20° to 30°. By ‘maximum’ angle of inclination is meant the peak inclination of the inclined area; for example, where the inclined area includes both a first region inclined at 5° and a second region inclined at 20°, the maximum angle of inclination is 20°.

However, the manufacturing process can be simplified through making the annular region generally flat. This would result in a diaphragm having reduced rigidity compared to a diaphragm that instead includes an inclined area. In particular, having a generally flat annular region was found to make the diaphragm susceptible to bowing in/out on application of a pressure differential to the diaphragm surface. However, this problem has been reduced through use of a diaphragm with an increased thickness. For example, using aluminium foil sheet with a metal thickness of 120 microns and a generally flat annular region, was found to result in equivalent pressure performance to that of a diaphragm formed of 90 microns thickness with an inclined area in the annular region. In this context, “generally flat” is understood to also allow for where the annular region includes one or more beads/corrugations, as long as the overall profile described by the annular region is flat.

There is a transition region between the annular region and the shaped cavity, the transition region defining the periphery of the cavity. Preferably, this transition region is formed with a radius of curvature in the range of 2 to 7 millimetres. It has been found that providing such a radius assists in successful formation of the cavity, by reducing the stress concentration that would occur at the transition region during forming of the cavity. Consequently, providing such a radius of curvature maximises the probability of successfully forming the cavity.

Conveniently, the diaphragm is attached to a surface incorporating a scraping edge, at least part of the scraping edge extending linearly to define a chord on the surface. This surface may be provided by an intermediate component of the type described above, such as an annular ring. Alternatively, where the diaphragm is attached directly to the sidewall of a container body, the sidewall itself would incorporate the scraping edge. Particular care would need to be taken in the forming of the diaphragm between that part of the diaphragm which is adjacent to the scraping edge and the remainder of the diaphragm, due to the change in geometry that would occur at this interface. The provision of such a scraping edge provides the advantage of enabling a user to efficiently level the contents of a conventional spoon which has been overfilled with material dispensed from the container, by drawing the spoon against the linear part of the scraping edge.

In a second aspect of the present invention, there is provided a container comprising a container body having a sidewall and a base, characterised in that the container includes the diaphragm previously described.

In a preferred embodiment, the diaphragm is peelably sealed to an open end of the container body along a sealing surface, the sealing surface inclined at between 45° to 135° relative to the longitudinal axis of the container. As described above, the sealing surface may be provided by an intermediate component—such as an annular ring—which is, in turn, attached to the container body. Alternatively, the diaphragm may be attached directly to the sidewall of the container body, the sidewall providing the sealing surface. The peelable seal may be facilitated as previously described. The use of a peelable seal assists in minimising the effort required to remove the diaphragm from the container by allowing the use of an efficient peeling action when removing the diaphragm. It has been determined that inclining the sealing surface at between 45° to 135° is most beneficial for ensuring that a peeling action can be used to remove the diaphragm. Most preferably, the sealing surface is perpendicular to the longitudinal axis of the container.

In a further embodiment, detaching means of the type previously described would be located locally to the periphery of the diaphragm to assist in the use of an efficient peeling action to remove the diaphragm from the container.

Although forming the diaphragm so that it has a shaped cavity enhances the stiffness/rigidity, there remains a risk that when a container comprising the diaphragm of the present invention is subjected to certain environments where the pressure inside the container is greater than the pressure outside the container (i.e. a pressure differential), all or part of the diaphragm may distort. This risk would be present, for example, when transporting such a container in the pressurised cabin of an aircraft or when moving from a location at low altitude to one at high altitude. A known way of minimising the risk of this problem occurring would be to attach a closure which includes the diaphragm onto a container under vacuum conditions, such as by using vacuum seaming. However, this would increase the complexity and costs of the packaging process.

Consequently, there is a need for a means of further enhancing the resistance to distortion of the diaphragm of the present invention when a container incorporating the diaphragm is subjected to a pressure differential.

Accordingly, in a third aspect of the invention, there is provided a reinforcing support which comprises an annulus profiled such that it corresponds with and is locatable against all or a substantial part of the annular region of the diaphragm, characterised in that the annulus is hollow in cross-section about all or part of the annulus, the hollow annulus thereby defining an open recess, and a tamper evident band is provided to cover the opening of the recess to thereby define a generally planar surface.

By profiling the annulus profiled such that it corresponds with and is locatable against all or a substantial part of the annular region of the diaphragm, the reinforcing support resists the tendency for the diaphragm to distort when subjected to a pressure differential. Alternatively or in addition, the reinforcing support is profiled such that it is locatable against all or part of the cavity of the diaphragm.

The reinforcing support is conveniently made from a plastics material to minimise weight. Known techniques such as injection moulding may be used to manufacture the reinforcing support.

In its simplest form, the reinforcing support may simply consist of an annular ring, which in use would sit on top of the annular region of the diaphragm when the diaphragm is used for a closure on a container body. In order to retain the reinforcing support in position, a secondary closure interfacing with the periphery of the container body may also be placed over the reinforcing support and diaphragm. The secondary closure may for example, be provided by a plastic lid having a generally planar profile, the periphery of the lid provided with a downwardly extending wall section which would interface with the periphery of the container body with a “snap-fit” connection.

Providing the annulus with a hollow cross-section helps to minimise the thickness and weight of the reinforcing support compared to merely forming the reinforcing support as a homogenous solid entity. The hollow cross-section may extend about all or part of the annulus; maximising the circumferential extent of the hollow cross-section will increase the weight and cost savings. The weight and cost savings of a hollow annulus will be particularly noticeable when making the reinforcing support for a diaphragm having one or more inclined areas, because it would:

a) allow the reinforcing support to be correspondingly inclined to enable it to locate against the one or more inclined areas of the diaphragm, and
b) enable the opposing surface of the reinforcing support to define a generally planar surface, thereby enhancing stackability,
c) (a) and (b) both being achieved with less material than would be needed if the reinforcing support were formed as a homogenous solid entity.

Locating the removable tamper evident band above the recess results in the recess being closed and thereby avoids unwanted matter (such as dirt) collecting in the recess, whilst also providing assurance to an end-consumer that a container incorporating the reinforcing support has not been tampered with. Providing a generally planar surface enables easy stacking of containers incorporating the reinforcing support. The tamper evident band may incorporate a tear-off strip.

In a further embodiment, the reinforcing support is adapted to be releasably attachable to a container comprising the diaphragm of the present invention so as to provide a reusable seal between the inside and outside of the container. This aspect of the present invention enables a seal to be maintained between the contents of the container and the environment outside of the container even after the diaphragm has been removed. Maintaining such a seal may be particularly advantageous when considering containers for storing perishable products, such as foodstuffs. Further, it may also avoid the need for a secondary closure in order to retain the reinforcing support in position. Conveniently, the reusable seal may be provided by a snap-fit connection between all or part of the periphery of the reinforcing support and the diaphragm/container. In these situations, the reinforcing support would, in use, be performing the following roles:

a) resisting distortion of the diaphragm of the present invention when the container is subjected to a pressure differential;

b) covering and protecting the thin material of the diaphragm; and/or

c) sealing and maintaining the freshness of the contents of the container once the diaphragm has been removed.

In a further embodiment, the reinforcing support further comprises retention means for releasably retaining a spoon. Most preferably, the reinforcing support is adapted to retain the spoon such that, in use, the spoon is suspended above and/or extends into the cavity of the diaphragm.

It is to be understood that the reinforcing support may be incorporated into a container comprising the diaphragm of the present invention. Preferably, the container further comprises a hinge about which the reinforcing support is pivotable. This avoids the reinforcing support becoming separated from the container once the container has been opened.

In known containers with a cylindrical cross-section used for storing non-liquid matter, the non-liquid matter is typically removed with a spoon (or similar utensil provided with a scoop portion). An end-consumer would typically level the contents of the spoon by drawing the spoon against the curved internal periphery of the container body in order to:

a) remove excess non-liquid matter; and

b) thereby ensure that a precise quantity of matter is contained within the spoon.

However, known spoons typically have a scoop portion with a periphery describing a generally planar surface. When drawing the planar periphery of the known spoon—when overfilled with non-liquid matter—against the curved internal periphery of the container body, the result is a heaped spoonful of matter in the scoop portion. The profile of the heap is arcuate and—for a given spoon—increases with the curvature of the internal periphery of the container body. The heaped spoonful of matter is particularly unstable and prone to spillage.

Consequently, there is a need for a spoon which reduces the likelihood of unwanted spillage when drawn along a curved internal periphery of a container body.

Accordingly, in a fourth aspect of the present invention, there is provided a spoon for use with a container for storing non-liquid material, the spoon comprising a scoop portion for dispensing non-liquid material from the container, wherein the periphery of the scoop portion describes a nonplanar surface which is profiled such that when the scoop portion, when overfilled with non-liquid matter, is drawn against the internal periphery of the container, excess non-liquid matter is thereby removed from the scoop portion such that the profile of the non-liquid matter remaining within the scoop portion perpendicular to both the direction of drawing and the longitudinal axis of the scoop portion defines a generally linear ridge.

The non-liquid matter contained within the scoop portion of the spoon of the present invention now only appears heaped when viewed at orientations other than perpendicular to the direction of drawing and the longitudinal axis of the scoop portion. Consequently, the spoon of the present invention has a reduced tendency for undesired spillages and provides greater certainty as to the quantity of non-liquid matter contained in the scoop portion.

Whilst the spoon is ideally suited for non-liquid matter, it may also be suitable for use with viscous liquid matter.

In a further aspect of the present invention, there is provided a container comprising the spoon of the present invention.

Preferably, there is provided a container comprising the spoon, reinforcing support and diaphragm of the present invention. The spoon may be housed within or adjacent to the cavity of the diaphragm.

### BRIEF DESCRIPTION OF THE DRAWINGS

An embodiment of the present invention is described below with reference to the following drawings:

FIG. 1 shows a perspective view of a closure incorporating a diaphragm of the present invention.

FIG. 2 shows a cross-section through the diaphragm of FIG. 1.

FIG. 3 shows a perspective view of a container incorporating the closure of FIG. 1.

FIG. 4 shows a cross-section through the container of FIG. 3.

FIG. 5 shows a detailed cross-section through the container of FIG. 3 when further incorporating the reinforcing support of the present invention.

FIG. 6 shows the container of FIG. 5, with the reinforcing support pivoting about a hinge to expose the diaphragm underneath.

FIG. 7 shows a perspective view of the container of FIG. 5, further incorporating a tamper evident bard.

FIG. 8 shows a perspective view of the spoon of the present invention.

FIG. 9 shows a side elevation view of the spoon of FIG. 8 in the direction of arrow A.

FIG. 10 shows a side elevation view of the spoon of FIG. 8 in the direction of arrow B.

### MODE FOR THE INVENTION

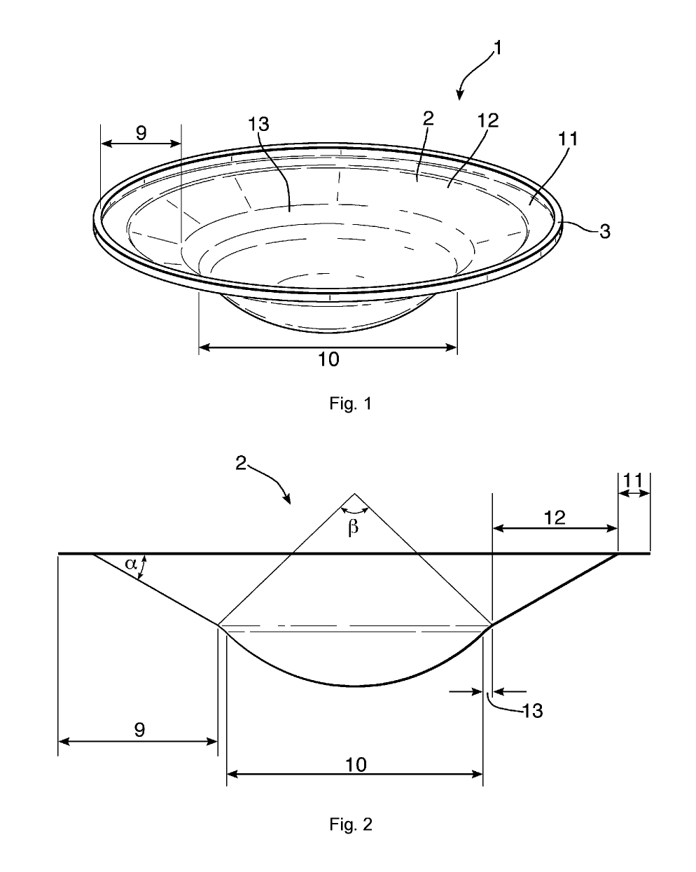

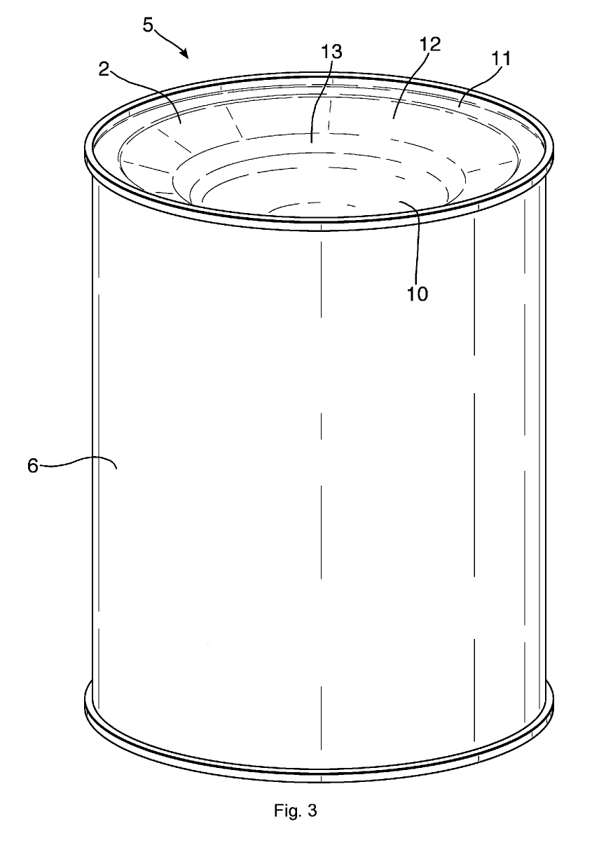

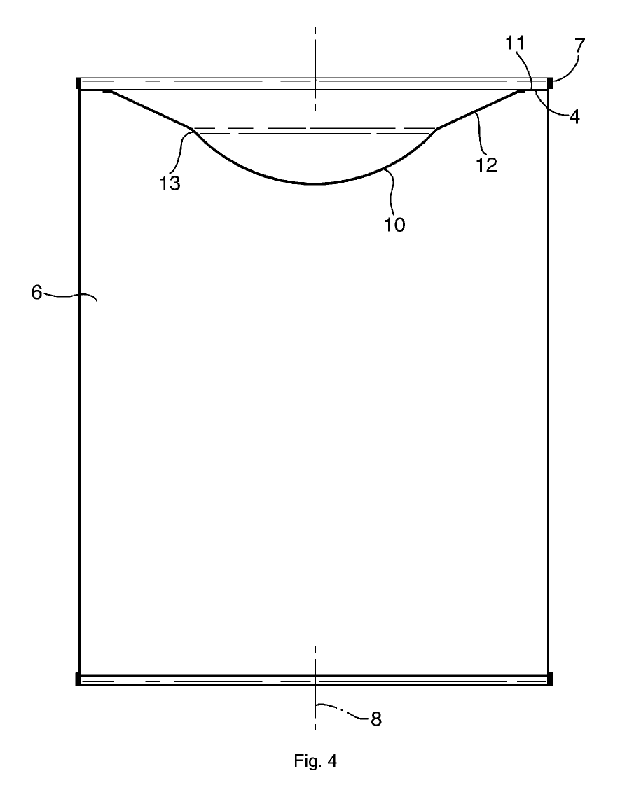

As shown in FIGS. 1, 3 and 4, a closure 1 is formed by a diaphragm 2 sealed to an annular metal ring 3 along a sealing surface 4. The closure 1 is seamed onto an access opening 5 of a metal can body 6 by the use of a double seam 7 (see FIG. 4). The sealing surface 4 is approximately perpendicular to the longitudinal axis 8 of the can body 6 (see FIG. 4).

As shown in FIGS. 1 and 2, the diaphragm 2 has an annular region 9 which surrounds a shaped cavity 10. The annular region 9 consists of a flat annular area 11 located at the periphery of the diaphragm 2 and an inclined area 12 situated inwardly of the annular area 11. The diaphragm 2 is provided with a radius of curvature of approximately 5 millimetres at the transition 13 between the annular region 9 and the cavity 10. The transition 13 defines the periphery of the cavity 10, i.e. the point from which the cavity depth is measured. The cavity 10 is generally part-spherical in shape.

As shown in FIG. 2, the inclined area 12 is inclined at an angle a of approximately 30° and the angle β described by the arc of the part-spherical cavity 10 is approximately 92°. Although not shown explicitly in any of the figures, the diaphragm 2 is formed from a strengthening layer of aluminium foil of 90 microns thickness coated with a peelable bond layer of heat sealable material, in this case polypropylene.

In an alternative embodiment, there is no inclined area, with the annular region 9 instead being generally flat. By increasing the aluminium foil thickness to 120 microns, the diaphragm with the generally flat annular region was found to provide equivalent performance against pressure differentials to a diaphragm with an inclined area.

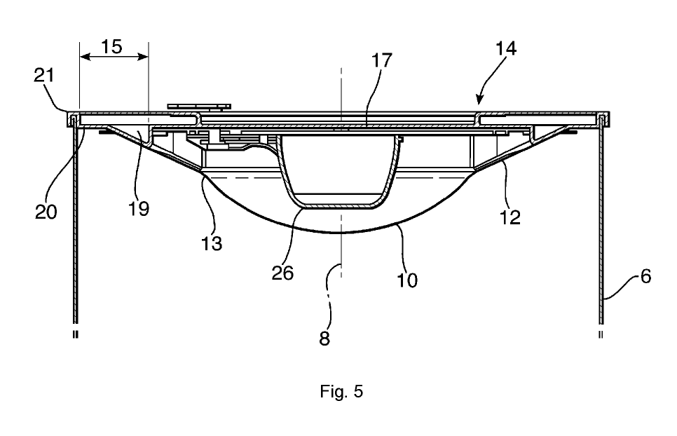

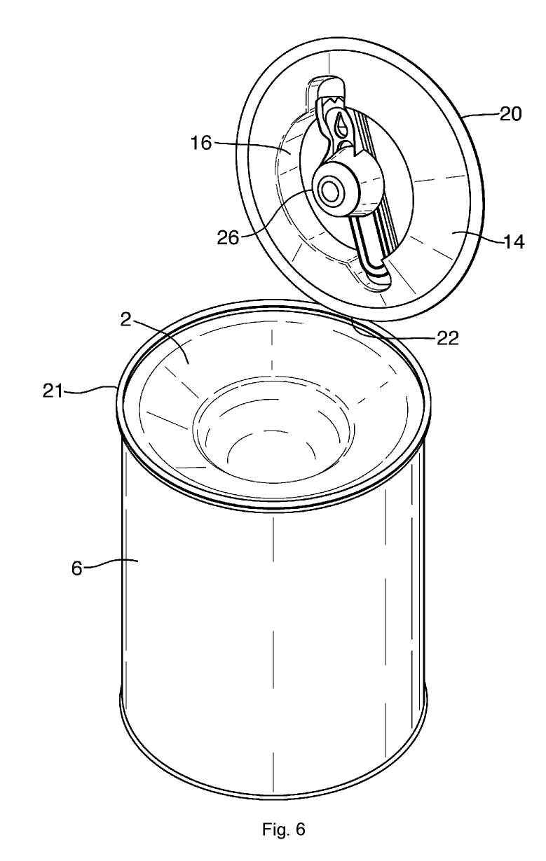

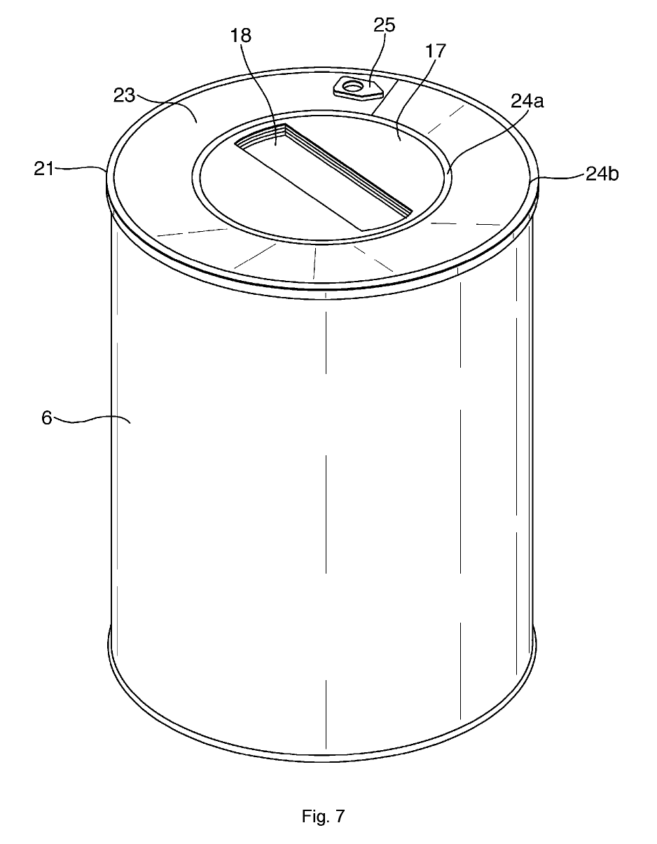

As seen in FIGS. 5 and 6, the can body 6 is provided with a reinforcing support 14. The reinforcing support 14 has an annulus 15, a lower surface of which is profiled to correspond with and be locatable against the flat annular area 11 and part of the inclined area 12, thereby offering resistance against distortion of the diaphragm 2 when the can body 6 is subjected to a pressure differential. At the innermost region of the annulus 15, a cylindrical wall section 16 (see FIG. 6) extends first upwardly and then inwardly to define a planar surface 17 (see FIG. 7) above the cavity 10. A recessed handle 18 is provided in the planar surface 17 (see FIG. 7). The reinforcing support 14 is hollow in cross-section, thereby defining a recess 19 between the cylindrical wall section 16 and the periphery 20 of the reinforcing support. The reinforcing support 14 is situated on top of the diaphragm 2.

As shown in FIGS. 5 and 6, at the periphery 20 the reinforcing support 14 interfaces with a U-section 21, the U-section extending over the double seam 7 to attach to the periphery of the can body 6. A hinge 22 (not shown in detail) is provided between the reinforcing support 14 and the U-section 21 (see FIG. 6). A reusable snap-fit connection (not shown) is provided at the interface between the periphery 20 and the U-section 21 to thereby provide a reusable seal between the inside and outside of the can body 6.

As shown in FIG. 7, a tamper evident band in the form of a tear-off strip 23 is provided between the cylindrical wall section 16 and the U-section 21 to cover and close the recess 19. The tear-off strip 23 is defined by v-section channels 24a, 24b which define lines of weakness along which the tear-off strip 23 may be torn. The tear-off strip 23 is provided with a tab 25 to assist in its removal.

The underside of the planar surface 17 is provided with means (not shown) for detachably retaining a spoon 26 above and within the cavity 10.

In the embodiment shown in the figures, the reinforcing support 14, U-section 21 and tear-off strip 23 are formed from a plastics material.

A consumer would open a can of the type shown in the figures as follows:

First, the consumer would remove the tear-off strip 23 by pulling on the tab 25 (see FIG. 7), resulting in the tear-off strip progressively separating along the v-shaped channels 24a, 24b in a tearing manner. The user would engage their fingers with the handle 18 and pivot the reinforcing support 14 about the hinge 22 in order to gain access to the diaphragm 2 (see FIGS. 6 & 7). The diaphragm 2 would be peeled from the can 6 to gain entry to the can's contents (not shown). The user would then detach the spoon 26 from the reinforcing support 14 and use it to dispense the can's contents.

In an alternative embodiment, the spoon 26 may simply be located to rest on the bottom of the cavity 10. As a further alternative, the reinforcing support 14 may simply be completely detachable from the container and not include the hinge 22.

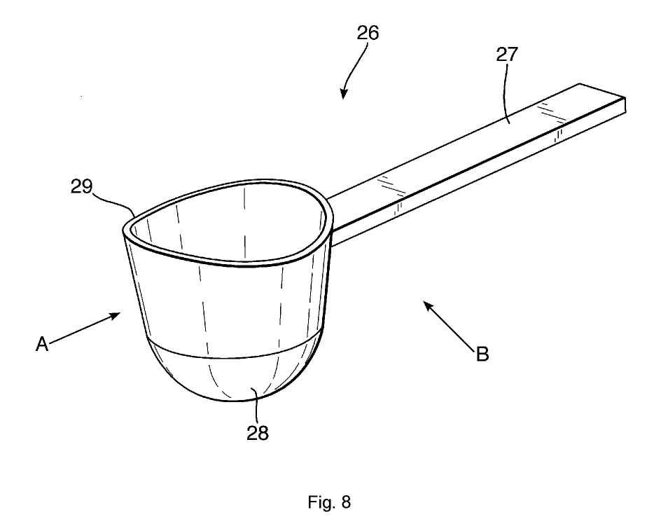

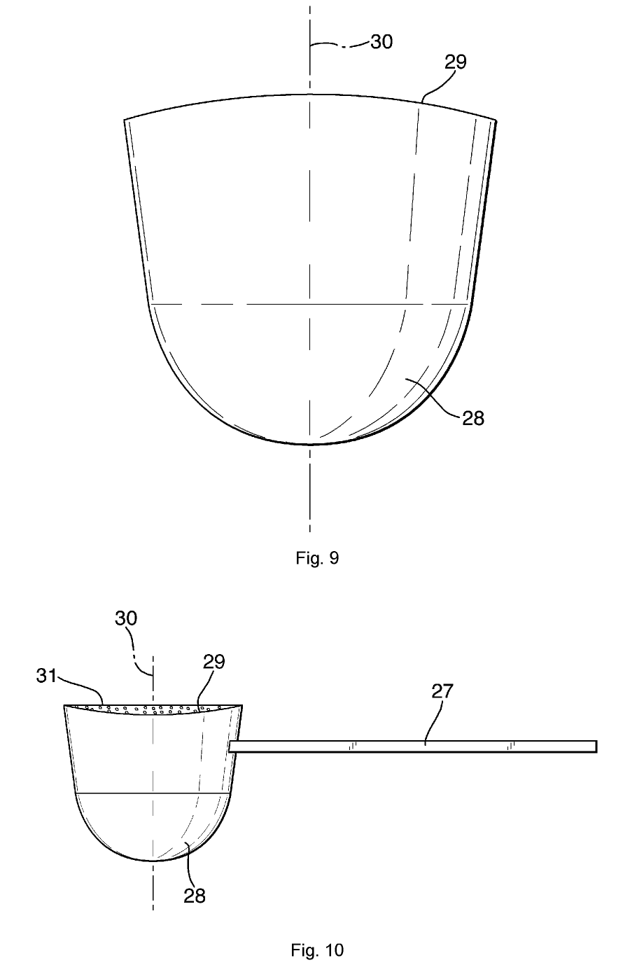

As shown in FIGS. 8 to 10, the spoon 26 has a handle 27 and a scoop portion 28. The periphery 29 of the scoop portion 28 is shaped to define a nonplanar profile. In use, the scoop portion 28 would be inserted into the can 6 to first provide a heaped spoon of material in the scoop portion 28. The periphery 29 of the scoop portion 28 is such that when the scoop portion is drawn along the internal periphery of the can 6, excess non-liquid material is removed from the scoop portion 28, such that the profile of the non-liquid matter remaining within the scoop portion perpendicular to both the direction of drawing and the longitudinal axis 30 of the scoop portion defines a generally linear ridge line 31. In this embodiment, the spoon 26 is made from a plastics material to minimise weight. However, the spoon 26 may also be made from alternative materials such as metal.

1. A diaphragm for a closure for sealing an access opening of a container body, the diaphragm being semi-rigid and formed with an annular region surrounding a shaped cavity.

2. A diaphragm as claimed in claim 1, wherein the shaped cavity is formed with a ratio of major diameter to cavity depth within the range 2.6:1 to 5.5:1.

3. A diaphragm as claimed in claim 1, wherein the cavity is generally part-spherical in shape and describes an arc in the angular range 80° to 150°, the arc being in a plane parallel to the longitudinal axis of the diaphragm.

4. A diaphragm as claimed in claim 1, wherein the diaphragm is formed from a single piece of unperforated foil.

5. A diaphragm as claimed in claim 4, wherein the diaphragm is a foil with a metal thickness in the range 20 to 170 microns.

6. A diaphragm as claimed in claim 5, wherein the metal thickness is in the range 90 to 150 microns.

7. A diaphragm as claimed in claim 1, wherein the diaphragm is adapted to be peelably removable from the container.

8. A diaphragm as claimed in claim 1, wherein the annular region is formed with at least one inclined area extending about all or part of the annular region and converging towards the shaped cavity.

9. A reinforcing support for use with a diaphragm, for a closure for sealing an access opening of a container body, the diaphragm being semi-rigid and formed with an annular region surrounding a shaped cavity the reinforcing support comprising an annulus profiled such that it corresponds with and is locatable against all or a substantial part of the annular region of the diaphragm, characterised in that the annulus is hollow in cross-section about all or part of the annulus, the hollow annulus thereby defining an open recess, and a tamper evident band is provided to cover the opening of the recess to thereby define a generally planar surface.

10. A reinforcing support as claimed in claim 9, wherein the reinforcing support is adapted to be releasably attachable to a container comprising the diaphragm so as to provide a reusable seal between the inside and outside of the container.

11. A reinforcing support as claimed in claim 10, wherein the reusable seal is provided by a snap-fit connection.

12. A reinforcing support as claimed in claim 10, wherein the reinforcing support is pivotally connected to the container.

13. A reinforcing support as claimed in claim 9, further comprising retention means for releasably retaining a spoon.

14. A reinforcing support as claimed in claim 13 adapted to retain the spoon such that, in use, the spoon is suspended above and/or extends into the shaped cavity of the diaphragm.

15. A spoon for use with a container for storing non-liquid material, the spoon comprising a scoop portion for dispensing non-liquid material from the container, wherein the periphery of the scoop portion describes a non-planar surface which is profiled such that when the scoop portion, when overfilled with non-liquid matter, is drawn against the internal periphery of the container, excess non-liquid matter is thereby removed from the scoop portion such that the profile of the non-liquid matter remaining within the scoop portion perpendicular to both the direction of drawing and the longitudinal axis of the scoop portion defines a generally linear ridge.

16. A container comprising:
a container body having a sidewall and a base,
a diaphragm closure for sealing an access opening of the container body, the diaphragm being semi-rigid and formed with an annular region surrounding a shaped cavity, and
a reinforcing support comprising an annulus profiled such that it corresponds with and is locatable against all or a substantial part of the annular region of the diaphragm, the annulus being hollow in cross-section about all or part of the annulus, the hollow annulus thereby defining an open recess.

17. A container as claimed in claim 16, wherein the diaphragm is peelably sealed to an open end of the container body along a sealing surface, the sealing surface inclined at between 45° to 135° relative to the longitudinal axis of the container.

18. A container as claimed in claim 16 further comprising a tamper evident band that covers the opening of the recess to thereby define a generally planar surface.

19. A container as claimed in claim 16 further comprising a spoon having a scoop portion for dispensing non-liquid material from the container, wherein the periphery of the scoop portion describes a non-planar surface which is profiled such that when the scoop portion, when overfilled with non-liquid matter, is drawn against the internal periphery of the container, excess non-liquid matter is thereby removed from the scoop portion such that the profile of the non-liquid matter remaining within the scoop portion perpendicular to both the direction of drawing and the longitudinal axis of the scoop portion defines a generally linear ridge.
